(19) United States
(12) Patent Application Publication
(10) Pub. No.: US 2009/0273786 A1
(43) Pub. Date: Nov. 5, 2009

(54) Stamp Identification Device

(76) Inventor: Helmuth Ölzant, Eichgraben (AT)

Correspondence Address: LADAS & PARRY LLP, 26 WEST 61ST STREET, NEW YORK, NY, 10023, US

(21) Appl. No.: 11/794,565

(22) PCT Filed: Jan. 23, 2006
(86) PCT No.: PCT/AT2006/000033

§ 371 Date: Jun. 29, 2007

(30) Foreign Application Priority Data
Jan. 27, 2005 (AT) A 128/2005

(51) Int. Cl. G01N 21/55

(52) U.S. Cl. 356/445

(57) ABSTRACT

The invention relates to a device for the automatic identification of stamps (4), which are provided with perforations (5) and are situated on letters. Said device comprises a light source (1), which illuminates at a shallow angle the letters that are displaced in one direction, a unit (6) for sampling the light beams (R) reflected by the stamps (4) and a unit (9) for evaluating the scanned light signals. The aim of the invention is to provide a stamp identification device with the highest possible identification rate and with a simple but robust construction. To achieve this, a prism (3) is located in the beam path of the light source (1), said prism being formed by a refraction prism with a perpendicular refraction of 50-70° and a horizontal refraction of 10-30°.

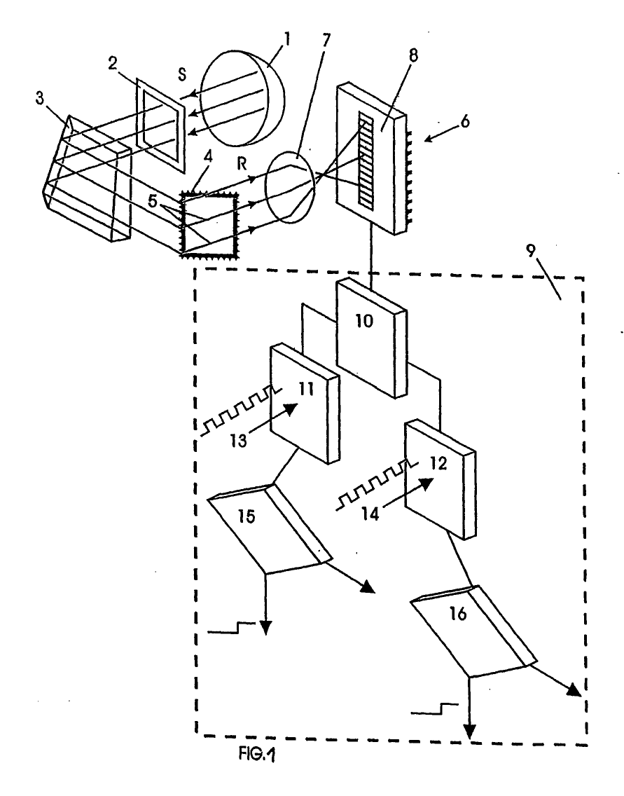

The invention relates to a device for automatic detection of stamps which are provided with perforation and are situated on letters, comprising a light source which illuminates the letters moved in a direction at a flat angle, and a device for scanning the light beams reflected by the letters and a device for evaluating the scanned light signals.

Several systems are known for detecting stamps in automatic mail processing. For example, specially prepared stamps are used, which, e.g., have been provided with phosphorescent or fluorescent layers on the surface of the stamp or which have been made of paper admixed with phosphorescent or fluorescent substances. A relatively reliable detection of the respective stamps is possible by means of sensors sensitive to phosphorescent or fluorescent materials. This involves the drawback of substantially higher costs for producing such stamps, since the production of coated stamps must be monitored thoroughly to ensure detection of the stamp afterwards. Another drawback of such systems is the sensitivity of the layer applied which may be removed when manipulating the letter.

Conventional stamps provided with perforation are partially replaced by overprints or by overprinted two-dimensional codes, which can be recognised by means of complex picture-processing methods. There is, however, a trend towards individual stamps provided with perforation, on which, e.g. a company introduces itsself, and which may be used for advertising purposes. Especially for such individual stamps, it is not possible to develop a detection method based on detection of certain colours or phosphorescent and fluorescent layers. Therefore, there is still the need for methods for detecting stamps provided with perforation, which are as simple and as quickly as possible.

EP 675 466 A2 and DE 101 59 234 A1 describe devices for analysing stamps or documents, in particular banknotes, wherein the picture of the respective document is analysed.

DE 102 34 431 A1 shows a device and a method for processing documents of value, wherein a safety feature thereof is checked.

Systems of the present kind are known, e.g. from AT 306 412 B and AT 355 358 B. These systems allow for detection of non-prepared stamps with substantially the same reliability as is the case with prepared stamps. The perforation on the edge of the stamp is used for detection. This perforation which has been produced with largely exact separation constitutes a reliable parameter of the stamp. The light source is arranged such that the light beams emitted by the same form an acute angle with the conveying direction of the letter. Thus, the stamps are illuminated by the light from the side such that the flanks of the stamp's perforation provided in parallel with the moving direction flash intensely. A low-frequency pulse sequence is produced in a device for scanning the light beams reflected by the letters, said sequence serving as criterion for the presence of a stamp in the subsequent evaluation device. There is, nevertheless, a certain error rate in detection of stamps, which is increased by the fact that the exact position of the stamp on the letter is unknown.

Therefore, the object of the present invention is to create one of the above systems for automatically detecting stamps provided with perforation, which is as simple, quickly and reliable as possible. Drawbacks of known systems shall be avoided or reduced.

The object according to invention is achieved in that a prism is arranged in the beam path of the light source, said prism being formed by a refractive prism having a vertical refraction of 50-70° and a horizontal refraction of 10-30°. Suprisingly, a substantial improvement of the detection is obtained by spectral dispersion of the light beams directed on the stamp. A better contrast of the stamp and its perforation to the envelope is accomplished by the refractive prism, whereby it is also possible to detect perforations of stamps on coloured background, e.g. on a black, gray or an orange envelope. The inventive device comprising the prism in the beam path of the light source is particularly robust, cost-effective and simple. Optimum results and high detection rates are achieved by means of the specifically adapted refractory prism. The scanning device and the evaluation device can be of substantially the same design as in conventional systems for detecting letters.

Advantageously, the prism is formed by a refractive prism having a vertical refraction of 60° and a horizontal refraction of 20°.

The detection rate can be further improved by arranging a screen between the light source and the prism. Light beams of the light source which are not emitted in the direction of the light-refractory prism are screened by the screen, which beams might lead to undesired effects on and influences of the measurement result.

The screen, in its simplest design, is formed by a tube. This is the simplest and most robust way of construction.

According to a further feature of the invention, the scanning device is formed by a CCD (charged coupled device) sensor. Such optical sensors are relatively cheap and allow for very quick processing of the sensor signals. The scanning device formed by the CCD sensor transforms the analogue light signal into a digital picture signal which is processed by the subsequent evaluation device. By means of an appropriately high-resolution CCD sensor, stamps provided with a finer perforation, such as, e.g. with 9-39 teeth per 20 mm, can be detected with a particularly low error rate. The detection rate of hitherto existing systems for detecting stamps was in the range of between 92-93%. With the new system detection rates up to 99.8% were reached. Thus, costs may be reduced enormously, since in automatic letter-sorting devices envelopes on which no stamp was detected are separated and checked manually. Hence, personnel and, consequently costs, can be reduced by using a system with a higher detection rate.

Advantageously, the CCD sensor is covered by a glass panel, preferably made of sapphiric glass. Thus, the sensor is protected from dust and the like, that, certainly, occurs with automatic letter-conveying devices.

Further improvements may be achieved in that the scanning device includes at least one optical lense. The use of one or several optical lenses in the beam path of the light beams reflected by the stamp, a bundle of the light beams in the direction of the optical sensor, e.g. the CCD sensor, can be obtained.

Evaluation of the scanned light beams may be effected particularly quickly and reliably using modern electronical apparatuses. Advantageously, the evaluation device includes at least one correlator for correlating the scanned light signals with at least one reference signal and/or reference pattern. By the aid of the correlator, the digital picture signal is compared with a reference pattern of the stamp, wherein the correlation parameters are entered appropriately and can be adapted individually. Known digital correlators exists of several shift registers which are suitably connected. If the correlation parameter that results from correlation of the digital picture signal with the reference pattern is above a certain threshold, detection of a stamp in proper form is indicated.

The detection rate may be further increased by the presence of two correlators for correlating the scanned light signals with at least two different reference signals and/or reference patterns. Of course, the evaluation can be further improved by certain detection algorithms.

The light source is preferably formed by a halogen lamp. Such lamps, as they are used, e.g., in projectors, yielded particularly good results and are, moreover, relatively robust.

Certainly, further devices may be provided for detecting additional features of the stamp, e.g. phosphorescent or fluorescent coatings. However, this requires the use of specially treated stamps. The coating of the stamp exerts no influence on the inventive detection device, which scans the flank and the perforation of the stamp.

The present invention will be described in more detail by way of the accompanying drawing which shows a block diagram of an embodiment variant of the device for detecting stamps.

A light source 1 emits light beams S which encounter the inventive prism 3 by a screen 2, where they are appropriately refracted. The light beams are directed on the stamp 4 present on an envelope (not illustrated) at a flat angle, where they are reflected on the side provided with the perforation 5. The reflected light beams R are received by a scanning device 6 which consists, e.g. of a CCD sensor 8 and an optical lense 7 optionally provided in front thereof. In the CCD sensor 8, which is, e.g. formed by a 256-pixel CCD sensor 8, the analogue signals are transformed into a digital signal which is suitably processed in an evaluation device 9. The evaluation device 9 may include a data filter 10 or one or several correlators 11, 12, said digital picture signal being compared with reference patterns 13, 14 therein. The output signal of the correlators 11, 12 are supplied to certain detection algorithms 15, 16, and, finally, a result on whether or not a stamp 4 in the proper form is present is obtained.

The method for evaluating the scanned light signals may be conducted in different ways.

1. A device for automatic detection of stamps (4) which are provided with a perforation (5) and are situated on letters, comprising a light source (1) which illuminates the letters moved in a direction at a flat angle, and a device (6) for scanning the light beams (R) reflected by the stamps (4) and a device (9) for evaluating the scanned light signals, characterised in that a prism (3) is arranged in the beam path of the light source (1), said prism being formed by a refractive prism having a vertical refraction of 50-70° and a horizontal refraction of 10-30°.

2. The device according to claim 1, characterised in that the prism (3) is formed by a refractive prism having a vertical refraction of 60° and a horizontal refraction of 20°.

3. The device according to claim 1, characterised in that a screen (2) is arranged between the light source (11) and the prism (3).

4. The device according to claim 3, characterised in that the screen (2) is formed by a tube.

5. The device according to claim 1, characterised in that the scanning device (6) is formed by a CCD sensor (8).

6. The device according to claim 5, characterised in that the CCD sensor (8) is covered by a glass panel, preferably made of sapphire glass.

7. The device according to claim 1, characterised in that the scanning device (6) includes at least one optical lense (7).

8. The device according to claims 1, characterised in that the evaluation device (9) includes at least one correlator (11, 12) for correlation of the scanned light signals with at least one reference signal (13, 14).

9. The device according to claim 8, characterised in that the two correlators (11, 12) for correlating the scanned light signals are provided with two different reference signals (13, 14).

10. The device according to claim 1, characterised in that the light source (1) is formed by a halogen lamp.

11. The device according to claim 1, characterised in that the devices for detecting additional features of the stamps (4), e.g. phosphorescent or fluorescent coatings, are provided.
